(19) United States
(12) Patent Application Publication
(10) Pub. No.: US 2005/0278195 A1
(43) Pub. Date: Dec. 15, 2005

(54) Method for scheduling viewing of a live medical procedure

(76) Inventor: Harry L. Getz, Laguna Niguel, CA (US)

Correspondence Address: COHEN SAKAGUCHI & ENGLISH LLP, 2040 MAIN STREET, 9TH FLOOR, IRVINE, CA, 92614, US

(21) Appl. No.: 10/856,132

(22) Filed: May 28, 2004

(51) Int. Cl. G06F 17/60

(52) U.S. Cl. 705/2

(57) ABSTRACT

A method for scheduling and viewing a live medical procedure is disclosed. The method may be practiced utilizing a system that includes: an image acquisition component, such as one or more video cameras, located at a site of the live medical procedure; a viewing component, such as a computer monitor, remotely located from the site of the medical procedure; and a database that is configured to store data regarding the scheduling and performance of the live medical procedure. The method involves providing data to the database regarding medical procedures to be performed. A viewer selects a desired medical procedure from the database, and registers to view the procedure at the specified time, then subsequently establishes a link between the viewing component and the image acquisition component. The image acquisition component transmits data, such as image data, over a computer network so the viewer can view the live medical procedure with the viewing component, as the procedure is being performed.

### FIELD OF INVENTION

The present invention relates generally to methods for scheduling viewing of live medical procedures. More particularly, the invention relates to a method for scheduling on-site or remote viewing of a live medical procedure over a network of computers, such as the Internet.

### INCORPORATION BY REFERENCE

The contents of each U.S. patent or other reference, if any, cited in this application, hereby incorporated herein by reference.

### BACKGROUND OF INVENTION

Computer networks, including the Internet, are useful for distributing audio and video signals to computer users at various locations. For example, several news channels, such as the websites for CNN, NBC, ABC, and CBS, may provide audio and video broadcasts which computer users can listen to and watch using a computer connected to the Internet. In addition, several sporting-related websites provide live audio/video broadcasts of sporting events. Video conferencing is also available between two or more computers in communication over a computer network. However, these existing types of audio/video broadcasts typically do not provide scheduling capabilities for the viewers, and do not permit viewers to select a particular broadcast from a group of potentially related broadcasts.

Computer networks, including the Internet, may also be useful for remote scheduling of events. For example, certain websites provide a calendar that may be accessed by a plurality of different computer users. The different computer users may enter and view information in the calendar to determine how events may be accommodated into their schedule. In addition, scheduling of rooms may be provided by certain computers to enable the users to establish a schedule. Web-based scheduling has been used in the medical setting to permit hospital staff, such as nurses, to schedule their work shifts from locations away from the hospital. Such web-based scheduling systems may be beneficial in creating work schedules, but such scheduling systems do not provide audio/video broadcasting capabilities combined with the ability to permit viewers to easily search and select a particular scheduled live event from a group of potentially related events.

Accordingly, there is a need for a new and improved system and method for scheduling remote or on-site viewing of live broadcasts, and in particular, a live medical procedure.

### SUMMARY

The present invention describes a system and method for scheduling viewing of a live medical procedure, such as an operation or surgical procedure being performed in a medical facility. The invention complements surgical education, medical procedure and product development. The invention encourages interest in procedures broadcasted by service providers, and may therefore result in enhanced education of the viewers.

Generally, a system includes a plurality of devices in communication with each other over a computer network. The system disclosed herein includes an image acquisition component configured to acquire an image of a medical procedure, a viewing component configured to display an audio and/or video broadcast of the medical procedure, a link between the image acquisition component and the viewing component, and a database configured to maintain a plurality of records associated with a plurality of medical procedures. As used herein, the image acquisition component may include a recording component, such as a component configured to record an image and store the image on a fixed tangible medium, and/or the image acquisition component may include a transmission component that is configured to acquire an image but not necessarily store the image data on a fixed tangible medium. One example of a transmission component may include a satellite transmitter. The system may also include a database management component and a reservation component. The database management component may be a part of the image acquisition component, or it may be a separate element of the system. The reservation component may be a part of the viewing component, or it may be a separate element of the system.

The system is used to schedule remote or on-site viewing of a live medical procedure. In one embodiment, from a viewer's perspective, a method in accordance with the present invention comprises: identifying a live medical procedure for viewing based on characteristics of the procedure; accessing a database; searching the database for data associated with the live medical procedure; and registering to view the live medical procedure. The characteristics of the live medical procedure that may be used as identifiers include a scheduled time in which the procedure is to begin, and a procedure type. Additional characteristics, such as instrumentation/devices used in a medical procedure (e.g., robotics), a specific instrument or medical device used in a medical procedure, and transmission or broadcast speed, may also be used as identifiers.

The database comprises a record associated with the live medical procedure. When a plurality (e.g., more than one) medical procedure is provided in the database, the database comprises a plurality of records. Each record comprises a plurality of data fields for storing data values. Each data field corresponds to a characteristic of the procedure, such as a time in which the procedure is to begin. As used herein, “time” refers to a single point in time or a time period/interval when an event occurs. After registration is completed, a viewer may view the live medical procedure. The viewer may be asked to provide identification information, such as an authorization code or a password, to be able to view the live medical procedure.

In another embodiment, a method for scheduling viewing of a live medical procedure comprises: providing a database with data corresponding to characteristics of a live medical procedure; receiving a request from a requestor to view the live medical procedure at a scheduled time; acquiring an image, such as a video image or a still image, of the live medical procedure at the time the procedure is performed; and transmitting data corresponding to the image of the live medical procedure to a remote viewing component. The transmission may occur substantially simultaneously with the acquiring. The characteristics of the live medical procedure that are entered in the database comprise the time in which the procedure is to begin, and the type of procedure. Additional characteristics may also be provided in the database.

Accordingly, the present invention provides a new and improved system and method for scheduling remote or on-site viewing of a live medical procedure, that contributes to medical education and improvements in medical procedures and products.

### BRIEF DESCRIPTION OF THE DRAWINGS

FIG. 1 is a block diagram of a system for scheduling remote viewing of a live medical procedure in accordance with the present invention.

FIG. 2 is a flow chart illustrating the steps of a method for scheduling remote viewing of a live medical procedure from the perspective of a medical procedure viewer.

FIG. 3 is a flow chart illustrating the steps of a method for scheduling remote viewing of a live medical procedure from the perspective of an administrator of the system of FIG. 1.

FIG. 4 is an illustration of a graphical user interface display divided into four partitions.

FIG. 5 shows sample records of the database of the system of FIG. 1 illustrating some typical data fields and values.

### DETAILED DESCRIPTION

A system and method are disclosed herein that enable a viewer to schedule remote and/or on-site viewing of a live medical procedure. The system and method utilize one or more databases to store data related to scheduled medical procedures. A requestor is able to search the database for a desired medical procedure, such as a medical procedure of interest to a viewer, and register, for example with a service, so that a viewer can view the live medical procedure at a scheduled time. The system and method provide a secure and convenient way for viewers to view live medical procedures from remote or on-site locations while maintaining or protecting patient privacy. Medical students, physicians, residents, fellows, nurses, and other professionals may benefit from the educational experiences gained from viewing such medical procedures. For example, such viewers can conveniently observe one or more live medical procedures being performed at more than one location from a single viewing site. Thus, the system and method provide a convenient and effective mechanism for arranging the viewing of live medical procedures by multiple people.

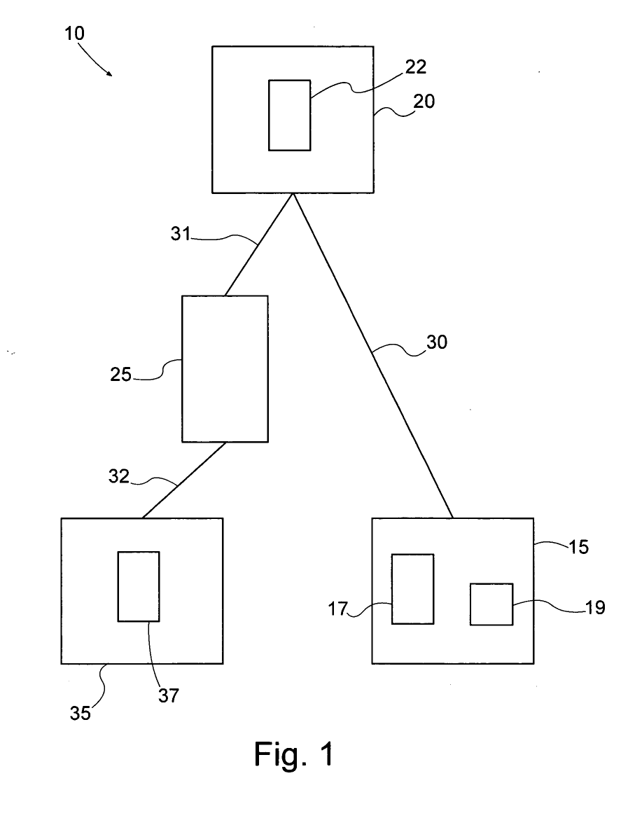

Referring to the figures, and FIG. 1 in particular, a system 10 for scheduling remote viewing of a live medical procedure is shown. The system 10 comprises an image acquisition component 15, a viewing component 20, and a database 25. The image acquisition component 15 and the viewing component 20 are in communication with each other by a link 30. The link 30 is effective to permit the image acquisition component 15 to transmit an electronic signal to the viewing component 20. The communication between the image acquisition component 15 and the viewing component 20 is preferably bi-directional; however, certain configurations of the system 10 may provide a unidirectional communication between the image acquisition component 15 and the viewing component 20.

The system 10 works in conjunction with a plurality of computers and related devices, such as computer peripherals, connected via a computer network. The computer network may be a local area network (LAN), a wide area network (WAN), a global communication network, such as the Internet, a virtual private network (VPN), integrated services digital network (ISDN), a satellite network and combinations thereof, or other methods of computer and video connectivity. The system 10 can include a variety of devices that are capable of being connected to a computer network thereby facilitating transmission and receipt of electronic information over the network.

For purposes of clarity and convenience, the system 10 schematically illustrated in FIG. 1 is shown in a simplified form. As will be apparent from the disclosure herein, the system 10 typically includes a plurality of devices, such as computers, monitors, routers, broadcasting devices, cameras, and the like, connected using conventional computer network technology and/or video conferencing technology. Computers used in the system 10 include any conventional computer, including personal computers, such as desktop or laptop computers, or computer servers. The computer typically includes conventional accessories, such as a keyboard, a computer mouse, and a monitor.

The components of the system 10 are in communication with each other by one or more links. The link may be any type of computer network communication path, including bi-directional and unidirectional communication paths. For example, the link may include a hard-wired connection between two or more computers, it may include a wireless connection between two or more computers, and it may even include a satellite communication path between two or more computers or video-conferencing systems. Thus, the system utilized to practice the methods of the invention may be more elaborate than that illustrated in FIG. 1 without departing from the spirit of the invention. In addition, the components of the system 10 are well-known and are publicly available from computer retailers and audio/video broadcasting companies. The components are connected via a computer network using conventional methods and protocols as understood by persons of ordinary skill in the art.

As shown in FIG. 1, the image acquisition component 15 comprises a computer 17 and a camera 19. The camera 19 may be an analog or digital camera, or a series of cameras. Preferably, the camera 19 is a video camera; however, the camera may also be a still image camera configured to acquire a plurality of still images in a short time frame or at short intervals. The camera 19 typically has an integral audio recorder permitting audio signals to be recorded and/or transmitted in addition to the video signals. However, in certain systems, an audio recording device may be provided as a separate element than the camera 19. When the video camera is an analog camera, or when any of the devices of the system 10 are analog, the system may include an analog-to-digital converter to facilitate communication between the analog device and a digital computer.

The image acquisition component 15 may also optionally include and/or work in conjunction with one or more patient monitors. The patient monitors may monitor various aspects of a patient on which the medical procedure is being performed. Examples of such monitors include heart monitors, blood pressure monitors, anesthetic level monitors, and the like.

The image acquisition component 15 may also include an audio/video feed device. The audio/video feed device is configured to transmit the information received from the other elements of the image acquisition component 15 to the viewing component 20 of the system 10. The audio/video feed device may be a separate element distinct from the other elements of the image acquisition component 15, such as the computer 17 of the image acquisition component 15, or the audio/video feed device may be an integral component of the computer 17. In some embodiments, the computer 17 may be coupled to the camera 19 so that audio and video recordings of the camera 19 can be transmitted to the computer 17 before being transmitted to the viewing component 20. The computer 17 may categorize and provide identification information to facilitate the management of the audio and video recordings.

The viewing component 20 of the system 10 comprises one or more monitors for displaying images obtained by the image acquisition component 15. For example, the viewing component 20 may include a computer 22, such as a personal computer having a monitor. As indicated above, a simplified viewing component 20 is illustrated in FIG. 1. In additional embodiments, the viewing component 20 comprises a plurality of monitors, including computers, connected to the image acquisition component 15 via a computer network. In addition, the viewing component 20 may comprise one or more video-conferencing terminals that operate without a separate computer.

The viewing component 20 and the image acquisition component 15 are coupled via a link 30. The link may also include a bridge device that is configured to broadcast audio and/or video signals recorded from the image acquisition component 15 to one or more monitors of the viewing component 20. In addition, the link 30 may include a router device that is configured to broadcast the audio and/or video signals to a plurality of computers or monitors of the image acquisition component 15.

The system 10 also comprises a database 25. The database 25 will be described in more detail herein. The database 25 is accessible by one or more remotely located computers. The remotely located computers include computers used to register a viewer to view a live medical procedure. However, the remotely located computers may also include computers used for data entry management and audio/video transmission management. Thus, the system 10 includes the database 25 configured to permit multi-user access to the database over a computer network for searching and reserving times to view a live medical procedure. One example of the database 25 is illustrated in FIG. 5, as described herein.

In addition, the system 10 may include a data management component 35, which comprises a computer 37. The data management component 35 is shown as being a distinct component from the image acquisition component 15. However, the data management component 35 could also be a sub-component of the image acquisition component 15. As shown in FIG. 1, the computer 17 of the image acquisition component 15 is different than the computer 37 of the data management component 35. For example, the computer 17 of the image acquisition component 15 may be located at or near an operating room of a medical facility, and the computer 37 of the data management component 35 may be located in an office of a medical facility, or in an office of a service provider that is independent of the medical facility. The data management component 35 is in communication with the database 25 via a link 32. For example, the database 25 may be provided with a computer server accessible over the Internet. The data management component 35 may be used to manage the database 25 over the Internet, such as by the link 32. For example, the data management component 35 may be used to populate, manually or automatically, the database with data regarding live medical procedures. The data management component 35 may also be used to manage user accounts, such as requestor and viewer accounts, and to facilitate establishing links between a viewer and the image acquisition component. Though the data management component 35 is shown as a single component in FIG. 1, this is for simplicity. Those skilled in the art would recognize that the data management component 35 may exist in multiple locations to allow multiple access points to the database 25. A typical example is that any PC or other device with access to the Internet may be a data management component 35 because such a device may then access and maintain/populate the database 25 overt the Internet.

The system 10 may also include a reservation component. For convenience in reference to the disclosure herein, the reservation component is the same as the viewing component 20, as shown in FIG. 1. However, in additional embodiments, the reservation component may be different than the viewing component. For example, the reservation component may include a computer in a physician's office, and the viewing component may be a video display in a hospital conference room.

An example in which the viewing component 20 and the reservation component are the same may be described as follows: a student may search and make a reservation to view a live medical procedure from his personal computer 22 in his home. The student may also view the live medical procedure from the same computer 22.

An example in which the viewing component 20 and the reservation component are different may be described as follows: a secretary may use his office computer to make a reservation for his physician employer to view a live medical procedure. The physician may then view the live medical procedure using a computer 22, or a video-conferencing system located in a conference room of a medical facility. The reservation component is in communication with the database 25 via a computer network connection, such as link 31.

The system 10 provides a secure connection enabling one or more viewers to view a live medical procedure utilizing videoconferencing and/or broadcasting services. The different components of the system 10 may use any communication protocol in order to permit a viewer to schedule and view a live medical procedure. The communication protocol may include conventional communication protocols, such as codecs over ISDN and satellite communications links, TCP/IP, and the like, as understood by persons of ordinary skill in the art.

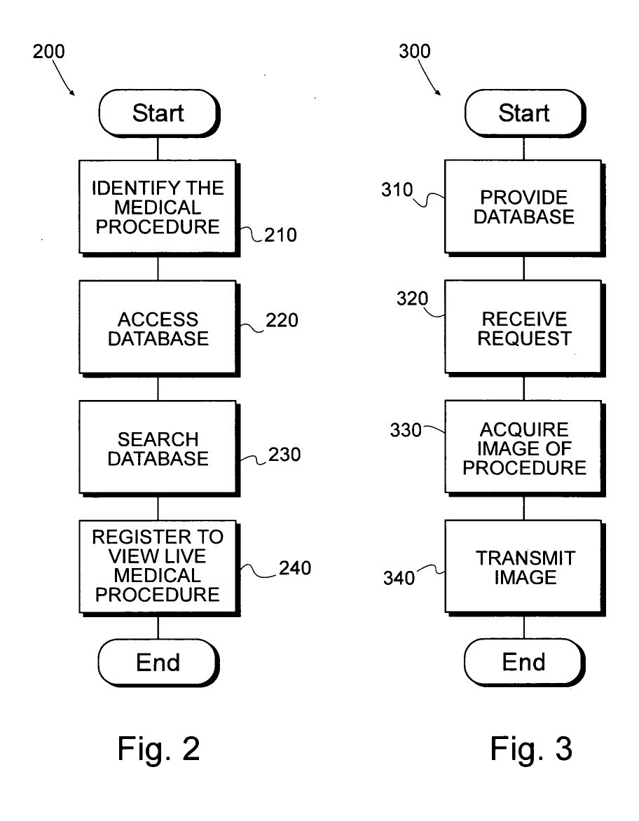

Turning to FIG. 2, a method 200 of scheduling remote viewing of a live medical procedure is illustrated from the perspective of a requestor. The requestor may be the viewer who is planning to view the live medical procedure, or the requestor may be a person who is authorized to schedule a viewing of a live medical procedure for a viewer. For example, the requestor may be a medical student, a medical intern, a medical resident, or a physician. The requestor may also be a person who evaluates medical procedures and medical products for future development. In addition, the requestor may be a secretary, a nurse, or another assistant who is scheduling a time for a viewer to view the live medical procedure.

As shown in FIG. 2, the method 200 comprises a step 210 of identifying a live medical procedure for viewing based on characteristics of the procedure. For example, the method 200 may comprise identifying selected characteristics of a live medical procedure for viewing. The live medical procedure can be any procedure that might be of interest to one or more viewers. In the illustrated embodiment of the invention, the live medical procedure is a surgical procedure or an operation performed in an operating room or any surgical center, or office where surgical procedures are performed, of a medical facility, such as a hospital.

The characteristics of the live medical procedure at least comprise a scheduled time in which the procedure is to begin, and a procedure type. For example, the scheduled time may be a specific date and time in which the medical procedure is to begin, or a range of time such as between 1:00 pm PST and 2:00 pm PST. The procedure type may include the type of operation being performed, and may be categorized on a variety of levels. For example, the procedure type may be listed as an orthopedic procedure, a cardiac procedure, a gastrointestinal procedure, and the like. In addition, the procedure may be identified as a hip replacement surgery, a cardiac bypass procedure, or a colonoscopy. The level of detail may vary, and multiple levels may be managed in the database to allow various levels of searching. Thus, the requestor may identify any live medical procedure at least based on the scheduled time of the procedure as well as the type of procedure. A requestor may “identify” a medical procedure by searching the database to find a procedure of interest, without having any preconceived idea or preference as to what procedure to view. The medical procedure may also be identified by a viewer responding to inquiries as to what types of medical procedures the viewer may be interested in viewing, and when the viewer is available, or by choosing a medical procedure based on subject matter currently being studied or practiced and looking at a schedule of availability. Other methods of identifying the live medical procedure are also encompassed, and are well-known in the art of database searching and querying.

In addition to the scheduled time and type of medical procedure, the live medical procedure may be identified by one or more additional characteristics. For example, the live medical procedure may be identified by one or more characteristics selected from the group consisting of a patient's gender, a patient's age, a body region on which the procedure is to be performed, a doctor performing the procedure, a doctor's school, a geographic location at which the procedure is to be performed, and any combinations thereof. In addition, characteristics may include types of instruments being used in a procedure, robotics, navigation, image data transmission speed, and the like. Each characteristic may be stored and managed in the database at multiple levels, to allow more comprehensive searching and selecting.

For example, the instrumentation characteristic might be useful if a particular medical device manufacturer decided to promote its new surgical device/instrumentation. The manufacturer may notify potential viewers of the opportunity to view the device/instrumentation in actual use by using a subscription service implementing the present invention to search for scheduled surgeries using the device/instrumentation. The same concept could be applied to pharmaceutical companies with new drugs and medicines. The transmission speed characteristic might be useful if a potential viewer had an option of multiple procedures to register for, and all else being equal or irrelevant to the viewer, one was being transmitted over a T1 line as compared to a slower dial-up connection. The viewer would likely choose the T1, or might even select the dial-up because of limited hardware at the viewing location.

The method 200 also comprises a step 220 of accessing a database configured to store information regarding medical procedures. One example of a database is shown in FIG. 1 and FIG. 5. The database may be accessed remotely or on-site. For example, the database 25 comprises a record associated with the live medical procedure. The record comprises a plurality of data fields corresponding to the characteristics of the live medical procedure, as described herein. Each of the plurality of data fields has a value corresponding to one of the characteristics of the medical procedure. When more than one medical procedure is identified in the database, the database comprises a plurality of records. Each record is associated with a live medical procedure to be performed, and comprises data fields representing a plurality of characteristics associated with the live medical procedure.

Another database may be provided in the system to store statistical information regarding the use of the system or one or more components of the system. For example, a database may include an aggregation of viewer and/or provider data. The viewer data may be anonymous. Such a database may be provided as a component of the database 25, or such a database may be a separate database which may be linked or coupled to another database using one or more relational database design procedures, as understood by persons of ordinary skill in the art.

The database 25 is remotely accessed over a computer network, such as by link 31, as shown in FIG. 1. As described herein, the computer network may be any type of network, including local area networks, wide area networks, global communication networks, virtual private networks, and the like. In one embodiment, the database is remotely accessed over the Internet. The database may be accessed using either a hard-wired network connection or link, or a wireless network connection or link, or a combination thereof. The database may be provided on a computer of the data management component 35, or the database may be provided on a network connected computer server that is not a part of the data management component 35.

The database can be built using any conventional database software, as understood by persons of ordinary skill in the art. For example, the database could be built or designed using a software program such as Microsoft Access®. The database is preferably accessible from a remote location over a computer network connection. The database is designed using conventional techniques used to design databases, such as relational databases. Thus, the database may include one or more tables. Each table may include one or more data fields. At least some of the data fields will correspond to characteristics of the live medical procedure. Each data field contains a value. The value corresponds to a characteristic of the medical procedure. When populated with data, the database permits a user to search for a desired live medical procedure by searching pre-populated menus of procedures, or by manually searching the records of the database. In addition, the records of the database can be sorted in any particular pattern that may help a requestor locate a live medical procedure.

As shown at step 230, the method 200 comprises a step of searching the database to identify the record for the desired live medical procedure. For example, the database may be searched to identify a first one of the plurality of records comprising data fields with field values matching the desired characteristics of the live medical procedure. The searching can be performed manually or automatically. For example, a manual search may require the requestor to view a plurality of records for characteristics associated with the medical procedure that are similar or identical to the characteristics used to identify the medical procedure, such as the scheduled time and type of procedure. An automated search of the database may require the requestor to run a query in the database for records that have values corresponding to the desired identification characteristics. In addition, an automated search may be conducted by a searching agent.

A search agent may be a software program provided as an element of the system 10, or may be a third party program that works independently, but in conjunction with the system 10. The search agent is configured to search through one or more databases for records of live medical procedures that may be of interest to a viewer. The search agent may be customized for a particular viewer. For example, the search agent may be customized to search a database for characteristics of a live medical procedure that equal or are in a range of values to live medical procedures that are of interest to a viewer. The search agent provides an automated means of searching databases for records of live medical procedures. The search agent may be configured to periodically search for records of live medical procedures at an interval desired by a requestor, for example, the search agent may search one or more databases on a weekly basis for records of live medical procedures that have characteristics selected by the requestor. The search agent may be configured to notify the requestor, or a viewer, when a record of a medical procedure has been identified that may be of interest. The notification may be an email, a text message on a cellular phone, a voice mail message, or an audible signal, among others, which may be activated within a user's profile upon a user's log-in to the system or a database of the system or in a user's personal list. Similarly, the system may notify each user upon log-in of any updates to the previously scheduled procedures to which the user has registered. The search agent may be programmed to search and identify records for specific live medical procedures described in a database using any suitable Boolean logic comparators.

The search may include entering one specific characteristic, such as a time the live medical procedure is to begin, or entering a range of characteristics, such as certain types of medical procedures of interest. Thus, the live medical procedure may be identified by searching for a characteristic, such as a specific date, that equals a value in a data field of a record of the database, or that is an exact match of the value in the data field. For example, the requestor may identify the live medical procedure as a medical procedure that is scheduled to occur on Jun. 10, 2005.

Alternatively, or in addition, the live medical procedure may be identified by searching for a characteristic within a range of values. For example, the requestor may identify the live medical procedure as a medical procedure scheduled to occur between Jun. 10, 2005 and Jun. 17, 2005. Other types of searches may also be useful in the method, such as combination searches. For example, the requestor may search for medical procedures occurring between June 10 and Jun. 15, 2005, but not on June 13, and that are for cardiac or orthopedic procedures. In addition, the searches may include any combination of Boolean logic criteria as understood by persons of ordinary skill in the art. Searching in general is well-known in the art.

The method 200 also comprises a step 240 of registering to view the live medical procedure at a scheduled time. As indicated above, the requestor may be the same as, or different than, the viewer of the live medical procedure. Thus, the registration step may be effective to register the requestor as a viewer, or it may be effective to register a different person or group of people to view the live medical procedure.

After registering to view a live medical procedure, the method 200 may comprise a step of viewing the live medical procedure at a location, such as at a remote location of the viewing component 20 shown in FIG. 1. The viewing location may also be at a location in proximity to where the live medical procedure is performed, i.e., in the actual hospital where the procedure is being performed, or even in the same room where the procedure is being performed, and may occur while viewing the live procedure simultaneously. In this sense, the situation in which the viewing location is within the same proximity as the live medical procedure is given as an example to distinguish from the situation in which the viewing component is at a remote location, where it is not physically practical or possible to view the procedure on site. The viewing may occur at a future time. For example, the viewer may view an audio and/or video broadcast of the live medical procedure from the viewer's residence, several days, weeks, or months after registering.

The method 200 may comprise a step of establishing a link, such as the link 30 shown in FIG. 1, between a recording component provided at a location of the live medical procedure and a remotely located viewing component. For example, a viewer may use a computer to establish a network connection to the image acquisition component located at the site of the live medical procedure. The viewer may be asked to provide identification information in order to view the live medical procedure. The link between the image acquisition component and the viewing component may be a direct link or an indirect link. For example, the link may be a direct link from the viewer's personal computer to a computer or transmission apparatus of the image acquisition component. Or, as in the illustrated embodiment, the link includes one or more routing devices located between the viewer's personal computer and the computer of the image acquisition component. The link may also be established between the viewer's personal viewing station and a digital camera of the image acquisition component, or the link may be established between the digital camera and a plurality of monitors of the viewing component. As described herein, the link may be established by submitting registration information to a computer configured to control transmission of an acquired video or still image of the live medical procedure to the remote viewing component.

The method 200 may also optionally comprise a step of interrupting the link between the image acquisition component and the viewing component. For example, the link may be interrupted after the live medical procedure is completed, such as when the patient is removed from the operating room. Or, the link may be interrupted during the live medical procedure as the viewer feels appropriate. The link may be interrupted by temporarily or permanently breaking the communication link between the image acquisition component and the viewing component. The link may be broken by logging off or exiting using the software program that has established the link. Or, the link may be broken by simply closing the program used to permit viewing of the live medical procedure. Thus, the program or one or more component of the system may include a “kill switch”-like device or component to terminate the link. In addition, the link may be broken by the transmitter of the system. The word “interrupt”, as used herein, refers to a break in communication between the viewing component and image acquisition component that prevents the viewer from viewing the live medical procedure until the link is reestablished or reactivated.

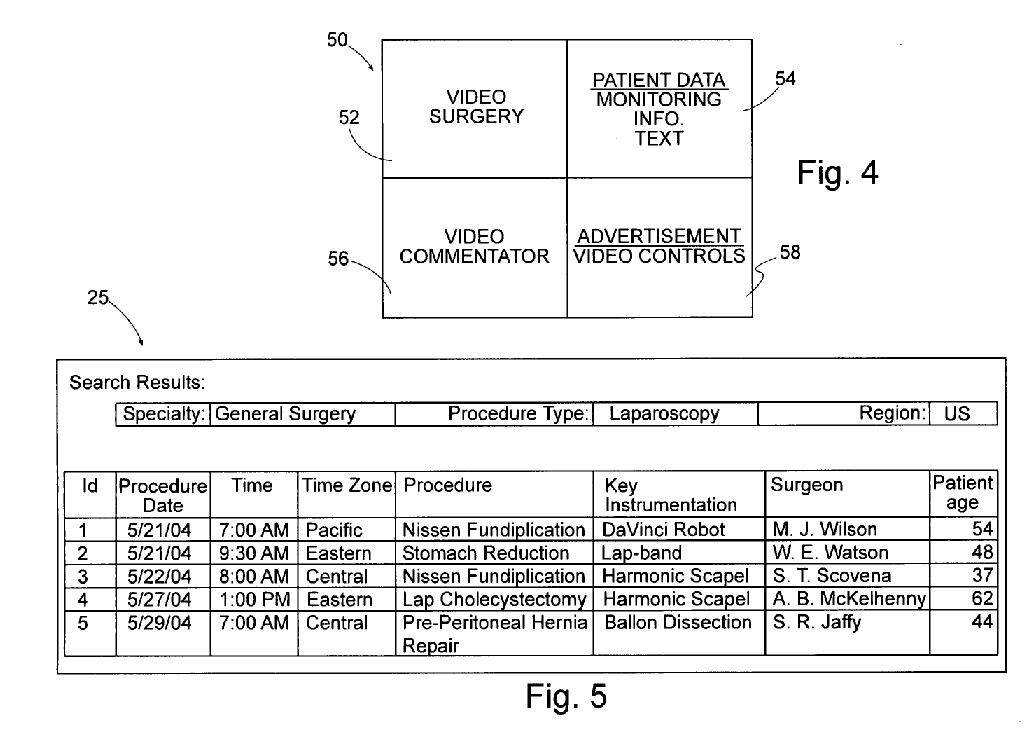

The live medical procedure may be viewed in a graphical user interface display of a monitor of the viewing component 20. For example, the graphical user interface may be a “window” of a conventional Internet web browser software program, such as Internet Explorer or Netscape Navigator. A schematic of a graphical user interface 50 is shown in FIG. 4.

The method 200 may also include a step of partitioning the display into a plurality of viewing components. The display 50 shown in FIG. 4 is partitioned into four viewing components 52, 54, 56, and 58. One of the viewing components, such as component 52, is configured to display a video image of the live medical procedure. The other viewing components may be configured to permit viewing of supplemental information associated with the live medical procedure. For example, one of the viewing components, such as component 54, may include text or other notes written by a participant located at the site of the medical procedure, or predetermined text entered into the database to be associated with the record of the live medical procedure in preparation for the transmission to viewing components. Another viewing component, such as component 56, may include a separate video display of a commentator of the procedure. The viewing components may also provide different views of the live medical procedure, may provide textual or graphic data regarding the procedure, or may even provide “chat” capabilities among viewers of the procedure. Some of the viewing components may permit the viewer or viewers of the display to enter information into a computer, for example, by taking notes during the procedure. The display may be partitioned by the viewer, by a third party, or by software of the system 10. For example, the image acquisition component may include software that broadcasts the information related to the live medical procedure so that the information can only be displayed in multiple partitions. In addition, the individual viewing components can be customized by changing their sizes, and position in the display as desired.

The method 200 may also include a step of viewing and listening to the live medical procedure. Audio and video signals may be transmitted over the same channel of the computer network or may be transmitted over separate channels. The viewer can determine whether he wants to watch the video and listen to the audio, or just watch the video. In addition, adjustments in display quality of either of the audio or video signals can be made independently.

The method 200 may also include a step or steps of receiving credits associated with viewing the live medical procedure. For example, a viewer may receive continuing education credits or class credits. Verification of the viewing of the medical procedure may be accomplished in a number of different ways. One way may include verification that the viewer was registered and logged-in to the procedure. Another way may be by providing a post-procedure exam for the viewer to complete.

By way of example, and not by way of limitation, the method 200 may be understood by the following specific hypothetical scenario. A medical student studying heart bypass procedures decides he would like to learn more about such heart bypass procedures by viewing a live heart bypass procedure. The student looks at his schedule for the upcoming week, and determines that Thursday afternoon, between 1 PM and 4 PM is available to him. The student uses his laptop computer in his home office to search a database through a service provider's Internet website for scheduled broadcasts/webcasts of heart bypass procedures. He searches the database and locates a heart bypass procedure being performed at 1:30 p.m. on Thursday. The procedure is being performed in another state by a physician that is well-regarded in the field of cardiac surgery. The student registers to view the heart bypass procedure by generating an account with the service provider and submitting payment to view the procedure using a credit card.

On Thursday, at 1:25 PM, the student uses his computer and the Internet Explorer web browser to log-in to view the medical procedure. He enters a password that he created, and a webpage is displayed on his computer monitor. The webpage consists of four frames, each frame displaying different information. One frame is a video image of the operating room. A second frame is a text display. The student understands that the second frame will display text of the steps being performed during the procedure. The third frame displays an image and text regarding the anatomy of the heart. The fourth frame displays an advertisement for surgical devices. At 1:30 PM, the surgeon is seen entering the operating room and beginning the procedure. The student is able to view and listen to the operation as it is being performed. After the procedure is completed, the student closes the web browser on his monitor, and prepares for his next class. The student may also take a few minutes, such as about 10 minutes, to complete a quiz or completion form in order to receive continuing education credits.

Turning now to FIG. 3, a method 300 for scheduling viewing of a live medical procedure from the perspective of an administrator or system manager is described. The method comprises a step 310 of providing a database with data corresponding to characteristics of a live medical procedure. As described herein, the characteristics comprise a time in which the live medical procedure is to begin, and a procedure type. In addition, the database may include one or more additional characteristics of the medical procedure that is(are) effective to facilitate a search for the medical procedure by a requestor. Examples of characteristics include, but are not limited to, a scheduled time in which the procedure is to begin, a procedure type, a patient's gender, a patient's age, a body region on which the procedure is to be performed, a doctor performing the procedure, a doctor's school, specific instrumentation, robotics, transmission speeds, and a geographic location at which the procedure is to be performed. One example of the database is shown at 25 in FIG. 5.

The method 300 also includes a step 320 of receiving a request from a requestor to schedule viewing of the live medical procedure at the time in which the procedure is to begin. As described herein, the requestor may be the same person as a viewer of the live medical procedure, or the requestor may be a different person than the viewer. The request may be made when the requestor submits payment to view the medical procedure, or it may be made as a separate step associated with the requester generating an account or making a reservation to view the image. As described herein, the live medical procedure may be any type of medical procedure, but in one embodiment, the live medical procedure is an operation performed in an operating room of a medical facility.

The request may be received before the live medical procedure is being performed, or it may be received as the live medical procedure is being performed. The request is typically received over a link of a computer network, such as a network connection between a remotely located computer and a computer configured to manage the database and/or transmissions of the system 10. In certain embodiments, the request comprises an identity of a computer or monitor of the remote viewing component.

At the time the procedure is being performed, the method 300 comprises a step 330 of acquiring the image of the live medical procedure. As discussed herein, the acquiring step may include a step of recording the image or image data onto a fixed tangible medium, and/or a step of transmitting the image or image data without recording the image or image data onto a fixed tangible medium. The image preferably is a live video broadcast of the medical procedure being performed. For example, the image may be one or more live video streams associated with a RealOne® player. Or, the image may be a video in another format that can be transmitted over a computer network for live or nearly live viewing of the medical procedure. In addition, the image may include one or more still images of the live medical procedure. When still images are utilized, it is desirable to transmit the images at a fast rate so that the images can be displayed rapidly and provide an impression of a video stream. In addition, the step 330 may comprise recording a video image and one or more still images of various aspects of the procedure, which are both capable of being transmitted to a viewing component of the system.

Data corresponding to the image of the live medical procedure is then transmitted to a remote viewing component as shown at step 340. As discussed herein, the remote viewing component comprises one or more monitors for displaying the image of the live medical procedure. In one embodiment, the method comprises transmitting the image of the live medical procedure to a plurality of monitors. The monitors may be monitors of a plurality of computers, and they may also include video display screens, and video conferencing terminals. The image or images may be transmitted to a computer server and accessed by viewers as a webcast through a web browser.

The method 300 may also comprise a step of registering a viewer to view the live medical procedure. The registering step may comprise associating the viewer with an authorization code, or other unique identifier. The authorization code may be a password, which can be created by the requester, the viewer, or software provided in a computer of the system 10. Or, the authorization code may include an identifier of a monitor of the viewing component, such as a machine address of a computer or an IP address of the computer that will be used to view the medical procedure. An authorization code is matched to a viewer or a group of viewers who are approved for admittance to view the live medical procedure. The authorization code may be generated in conjunction with a requestor selecting a password. In addition, the authorization code may permit a viewer to view one medical procedure, or a group of medical procedures depending on the interests of the viewer. Thus, when the requestor is going to view the procedure, the requestor may be registered as an authorized viewer of the procedure. The authorization code may allow the viewer to access his or her registration information even from a location different than the location in which the registration was created.

Although an image of the live medical procedure may be transmitted without sound, in certain embodiments, both audio and video signals of the live medical procedure may be transmitted to the viewing component. Thus, the method may further comprise a step of acquiring sound of the live medical procedure, and transmitting data corresponding to the acquired sound to the remote viewing component.

In addition, the method 300 may optionally include one or more steps of transmitting supplementary information related to the medical procedure. As used herein, “supplementary information” refers to information other than the audio and video broadcast of the live medical procedure. Examples of such information include textual information regarding steps of the live medical procedure, information regarding the doctor performing the procedure, information regarding anatomy and/or physiology of the structure on which the medical procedure is being performed, and advertisements. The supplemental information is preferably visual, and the information may be text-based, graphics-based, or a combination thereof.

The method 300 may also optionally include a step of sending an electronic notification of a change in scheduling of the live medical procedure. For example, if the time of the live medical procedure changes after a requestor has registered a viewer to view the live medical procedure, an electronic mail message may be sent to the viewer, or to the requestor, indicating the scheduled time has changed. Other electronic notifications may include text messages, voice messages, or other audible signals that may be transmitted to a computer, cell phone, personal digital assistant, and the like.

The method 300 may also comprise a step of submitting a payment request to the requestor to schedule the viewing of the live medical procedure. The payment request may include a credit card authorization, or an Internet-based payment system. The method 300 may also include a step of notifying the requestor whether the payment has been received.

The method 300 may also comprise a step of providing an authorization code that permits a viewer to view a plurality of live medical procedures at different scheduled times. For example, a requestor may wish to register to view a plurality of live medical procedures in advance by submitting payment for more than one live medical procedure viewing.

The method 300 may also comprise a step of saving data corresponding to the live medical procedure so that the live medical procedure can be viewed as a pre-recorded medical procedure. For example, the live medical procedure may be simultaneously saved as it is being viewed. The procedure may be saved by one or more computers. Saving the audio and video signals of the procedure may be desirable to allow viewers to watch the procedure again, or a portion of the procedure again.

As an example of the method 300 illustrated in FIG. 3, an administrator of a service provider, such as a provider of video broadcasts of medical procedures, has a database containing data corresponding to characteristics of a live medical procedure. One example of a database is illustrated in FIG. 5. The database is illustrated as including a plurality of data fields that include fields corresponding to characteristics of medical procedures, such as the date and time the procedure is to begin, the procedure type, the doctor performing the procedure, and the age of the patient. In addition, the database may include the transmission speed of the procedure, and the facility profile. The database in this example is maintained on a server computer located at the administrator's office. The database is accessible by a variety of network connections, including Internet connections. The database may also include a viewer profile or hospital profile.

The database is searched by a medical student looking for a live medical procedure to view. In particular, the medical student searches the database using his personal computer and accessing the database through an Internet website. After the medical student selects the hip replacement surgery scheduled for May 27, 2004 at 1:00 PM, a request is received to schedule a viewing of the hip replacement surgery by the medical student. The request includes payment for scheduling the viewing of the surgery by authorizing the administrator to charge the medical student's credit card. The request also includes a password to enable the student to establish a connection to an image acquisition component located at the site of the hip replacement surgery.

On May 27, 2004, the hip replacement surgery is begun and the procedure is acquired using a digital video camera. The video of the procedure is transmitted over a computer network. In particular, the audio and video signals are transmitted to the medical student's remotely located computer where the student watches the procedure as it is being performed. This is typically accomplished as a webcast, so that multiple viewers may view the same procedure by accessing the administrator's server through the Internet or using video-conferencing technology.

Another method of scheduling viewing of a live medical procedure may be understood from the perspective of a data entry subject. The data entry subject may be a person, or it may be a computer or software program configured to input data into a database.

The method comprises a step of accessing a database of a computer. The database is configured to store data corresponding to characteristics of a live medical procedure. The database may be structured similar to the database 25 of FIG. 5. The characteristics of the database comprise a time in which the procedure is to begin, and a procedure type, an optionally one or more other characteristics associated with the live medical procedure. After accessing the database, data corresponding to the characteristics is transmitted. This is also known as populating the database.

The transmitting step may be automated or manually performed. For example, a person may transmit the data to input the data into the database by entering the information with a keyboard of a computer. Or, when the database is automatically populated, a software program running on a computer may transmit data from one or more computer files, such as a delimited file, and enter the data into the database.

In some embodiments, the method may comprise additional steps of receiving information from a medical facility, and populating the database with the information. The information obtained from the medical facility is information corresponding to characteristics of one or more live medical procedures. For example, the method may comprise such steps when a service provider other than the medical facility is responsible for managing the database. In addition, the method may comprise a step of requesting payment from a medical facility to store the data corresponding to the live medical procedures performed at the facility. The method may include a step of notifying the payee whether payment has been received.

The method may also comprise a step of facilitating establishing a link between an image acquisition component located at a location at which the live medical procedure is to be performed, and a remotely located viewing component so that the live medical procedure may be remotely viewed at the time in which the procedure is performed.

As one example, a data entry person of Medical Video, Inc. may be responsible for inputting data into the company's database for scheduling remote viewing of live medical procedures. Medical Video, Inc.'s business includes receiving information regarding live medical procedures from different medical facilities around the country, and facilitating the viewing of such live medical procedures over computer networks by viewers located around the country. The data entry person opens the database to input data. The data entry person manually inputs information such as the procedure date, procedure time, procedure type, doctor, patient's age, and the like into the database. She obtains this information from medical facilities where the medical procedures are being performed. The updated database is then made accessible to computers located on the Internet. Medical Video, Inc.'s software also requests payment from the viewers to view the live medical procedure. Once the payment is processed, and the viewer attempts to log-on to the system to view the medical procedure, the software verifies that the viewer's registration information is accurate, and then proceeds to facilitate establishing a link between the viewer's computer and the image acquisition component.

In addition to the foregoing, the system 10 may be configured to generate or assign a value for a live medical procedure. Thus, the method 200 may include an optional step of assigning a value to the live medical procedure. The value may be generated or assigned manually or automatically (e.g., by preprogrammed software running on a computer). The value may be utilized to generate a cost for scheduling and viewing a live medical procedure. The value may be generated based on features such as costs for connection time, number of viewers, the type of viewer or viewers, time allocation for different components of the system, issuance of education credits, and similar broadcast offerings. In addition, a market value of the live broadcast may be assigned based on the number of similar or identical procedures, and the number of corresponding interested viewers. The ability to generate a value for a live medical procedure may be programmed into the database 25, or it may be a separate software program configured to utilize data stored in the database to generate the value. Such a value may be referred to as a “cost to attend” a live medical procedure.

The system 10 may also be configured to permit categorization of viewers and/or procedures, to differentiate between educational purposes and industrial or business-related purposes, and to differentiate by viewer, speaker, presenter, and the like. Categorization and other types of analysis may be effective in maximizing the number of viewers and medical procedures available, and in increasing revenue associated with operating the system.

The data management component 35 of the system 10 may be configured to retain requestor- or viewer-specific user settings or preferences that may facilitate more efficient data entry into and searches of the database 25. For example, the data management component 35 may include a requestor or viewer profile, and/or a facility profile. A user profile may include information such as payment methods, interests, billing information, biographical information, and the like.

The system 10 may be configured to limit the number of access-points or viewers that can remotely view a live medical procedure. For example, the system may be configured to limit viewing to a single viewing component at which one or more viewers can view the live medical procedure. Or, the system may be configured to provide an unlimited number of viewers to view a live medical procedure, the final number being the number of viewers who registered to view the procedure and who watched the procedure on a display of the viewing component linked to the image acquisition component.

The system and method described herein will facilitate “posting” of upcoming medical procedures, for example by a nurse or physician, and searching or seeking of a specific procedure for observation by doctors who may have access (through a medical facility) to complete an advanced on-line search, reserve and purchase a virtual seat.

The methods and system disclosed herein may also provide the ability for a viewer to notify one or more other people about the live medical procedure. The notification can occur before the live medical procedure or after the live medical procedure. This ability is similar to the “buddy-online” feature associated with may existing internet service providers and software. The use of this feature is conventional and well known to persons of ordinary skill in the art. In accordance with the present methods and system, a viewer can notify one or more other people when they are online or offline. The other people may be members of the system, who can be identified by the viewer based on their personal profiles, among other things. Thus, one member of the system may be able to determine what other people are members, and who among these other people are signed up for which live medical procedures. In addition, one member, such as the viewer, could determine what other people are actually viewing the same live medical procedure. This may be helpful in allowing a viewer to request to view the live medical procedure while the procedure is being performed because the viewer may see that another person whom the viewer knows is viewing the procedure.

The methods and system may also enable two or more viewers, who may be identified as described above, to communicate in real time before, during, or after the live medical procedure. The communication may include electronic communication, such as email and instant messaging. In one embodiment, instant messaging is preferred. The electronic communication may be provided by text displayed in one or more windows of the viewing component, as discussed herein. The system is typically configured so that privacy, security, and confidentiality are maintained using conventional techniques known by persons of ordinary skill in the art, for example, the system may include a switch which allows a viewer to activate or inactivate privacy features. Such a switch may be provided in a personal profile provided with the system.

The foregoing feature thus permits a viewer to notify other people, such as people provided in a “buddy-list” of the live medical procedure. For example, the viewer may notify the other people that a live medical procedure is scheduled, that the live medical procedure is being performed, or that a discussion regarding the live medical procedure is to occur after the procedure. Typically, the notification would not be provided to a general population of people, such as all of the members of the system, but only to a group of all the members, such as a group of people provided in a “buddy-list” and having one or more features in common, such as determined by personal profiles.

In view of the foregoing, a method of scheduling viewing of a live medical procedure from the perspective of a viewer, as described above may also comprise a step of identifying another viewer registered to view the medical procedure. The identification may include determining that the other viewer is viewing the event, such as by being logged on to the system, determining that the other viewer is a member of the system, or determining if the other viewer is registered to view the live medical procedure. In addition or alternatively, the method may comprise a step of notifying another person of the live medical procedure. The other person may be selected from a group of people identified in a list selected by the viewer, such as a buddy list. In addition, the notification could be sent to two or more people if those people are provided in the list. The method may also comprise a step of sending an electronic message to the other viewer to notify the other viewer of the live medical procedure. The electronic message may be displayed in one of a plurality of windows of the viewing component, as described herein. In certain embodiments, the electronic message is similar to “instant messages” which are conventionally known by persons of ordinary skill in the art.

Similarly, the method from the perspective of a service provider, as described herein, may comprise a step of receiving a request to identify another viewer registered to view the medical procedure. The request may be sent by the viewer or requestor scheduling viewing of the live medical procedure. The request may include one or more additional requests, such as sub-requests. These additional requests may include a request to determine whether the other viewer is viewing the live medical procedure, the other viewer is registered to view the live medical procedure, or that the other viewer is a member of the system. In addition or alternatively, the method may comprise the steps of receiving a notice regarding the live medical procedure from a viewer, and transmitting the notice to another person, as described above, such as a person of the viewer's buddy list.

The system may thus further comprise a list of names of people. The list is effective in facilitating electronic communication between people of the list. For example, the list may include one or more groups of people who share a common feature, such as medical specialty. The list provides a convenient way for a viewer to identify other members who share common interests and to communicate with the people. The interests and members of the groups may be associated with personal profiles associated with each person's information in the system.

A sample User Specification illustrating one embodiment of the present invention is set forth below.

*** Start of Sample User Specification ***

General User Set-Up

Establishing a New Facility (Member)

New facility completes a new “member” application [form on-line, or .pdf].
The ORNetwork establishes the new member profile and updates the ORNetwork system and database.
   Establishing a New User
New user completes “new user” form
The hospital ‘Master’ logs-in and establishes a profile, using information from “new user” form
ORNetwork system is updated with new user information & new user identification number is generated.
   A New User Profile & Personal References

After logging-in, the user may update their profile and preferences, by depressing the ‘profile’ tab.
Notifications—will establish a method for notification when new procedures are available.
Select ‘public’—to enable others to find this user through a ‘peer’ search on the system.

Others may then add you to their peer list.
Select ‘private’—to disable others from finding you through a peer search on the system.

In order to provide others your peer ID, in order to be added peer lists, (for more information see Peer-to-Peer settings).

Scheduling A SurgiCast™

Scheduling a SurgiCast™ Procedure

Log-in & passcode are required
Select the ‘schedule’ tab to input criteria for a new SurgiCast™.
Select the procedure type, instrumentation and specific criteria from the pull-down menus, [this information will be searchable by potential viewers]. Enter free-text in the ‘note’s section. Note: the highlighted areas must be completed before the schedule database can be updated.
Depress the ‘send’ button when all information is complete.
Depress the ‘save and send later’ button, if the information will be completed at a later time.
   Searching, Viewing and Selecting a Scheduled SurgiCast™ Procedure
   Searching for a SurgiCast™ Procedure
Log-in
Select the search tab to input criteria for a new search and depress the ‘send’ button. Procedures that match the selected criteria will be presented in a list, which may be sorted by chronology, surgeon, procedure type, instrumentation . . . .
System requirements for accessing the stream will be given.
Select the desired results, by placing a check-mark in the respective box(es) and depress the ‘filter’ button. A list of the selected SurgiCasts™ will be viewable.
   Selecting & Reserving a SurgiCast™ for Viewing
Once a SurgiCast™ procedure has been identified, select the desired procedure, by placing a check-mark in the respective box.
If CME credits are available for the desired program, a check box will allow selection of this option. If you wish to receive CME credit for viewing, click on the field, next to the option box labeled, “I wish to receive CME credit”. Next, click on the field, next to the box, “I agree to the payment of $______ for CME credit”.
Depress the ‘reserve’ button and complete the form, by selecting the pull-down menus and filling the required fields.
A confirmation will be given, which will list the specifics chosen, including the selection of CME credit. A viewing authorization number will be given, which may be required to access the video stream.
Viewing instructions will be available when logging in for viewing a SurgiCast™.
   Viewing a SurgiCast™ Procedure
Log-onto the ORNetwork.
Select the scheduled SurgiCasts™ tab.
Select the hyperlink to the desired SurgiCast™ procedure.
Follow the viewing instructions for logging in and viewing the SurgiCast™.
   Using a Search Agent
Select the “search agents” tab, for a list of upcoming and past procedures that meet the pre-selected criteria. If multiple search agents have been established, a list of agents will appear
Select the desired results, by placing a check-mark in the respective box (see ‘Searching’).
   Establishing a Search Agent
Select the topics and criteria of interest
Enter a check-mark next to the ‘type of notification’ requested and the necessary contact information required, (e.g. e-mail, pager, etc. . . . )
Place a checkmark in the ‘notify me’ box. The system will notify upon a match to the specified criteria.
   Receiving Continuing Education Credits
Continuing education credits are available through the ORNetwork (See “Selecting & reserving a SurgiCast™ for viewing”).
   Peer-to-Peer Set-Up & Communication

[Initially, a phone call is recommended, prior to initiating the video SurgiCast™, so that the link to the stream is expected].

Peer Identification

Each ORNetwork user will have a unique ‘peer’ identification, (pID), which is separate from the video system. The pID will enable senders of video to forward a link (from their ‘peer’ tab) to the appropriate viewer(s) on the system.
   Set-Up a New Peer in Your “Peer” Tab
Search for the name of the peer to set-up in the system. (It may be necessary to contact peers off-line, if their peer ID was made unavailable through their preferences).
Identify and select the peer, or enter the peer ID into the available field.
Depress the ‘complete’ button.
The new peer will be viewable in your peer list.
   Remove an Existing Peer from Your ‘Peer’ Tab
Select the ‘peer’ tab
Depress the ‘remove peer’ button
Check the box(es) associated with the peer that is to be removed.
Depress the complete button
You will be returned to the peer list, which will reflect the changes made.
   Initiating a Peer-to-Peer SurgiCast™
Log onto the ORNetwork™
The sender's IP address will be identified by the system to establish the ‘gateway’ for the signal stream, (this ensures security of the stream to the viewers).
Select the ‘peer’ tab.
Place a check mark by the viewer(s) intended to receive the video stream.
Depress the “Send” to send an invitation link to the selected viewers.
   Viewing a Peer-to-Peer SurgiCast™
Select the “Current SurgiCasts™” tab.
Select the hyperlink to initiate viewing of the live video signal. The video pathway is provided within the link, so that selection of the hyperlink will establish the connection to the video stream].
The viewer receives the link to the SurgiCast™ video signal, (The video signal is either decrypted by the receiver's system(s), or the authorization code (authorized link) enables access to the secure stream.
   Peer Preferences—(See ‘User Profile and Personal Preferences Set-Up)
   Peer-to-Peer Consult
   “Consult On”

When the surgeon wishes to notify his/her peers of current availability, the system sends a signal to the server providing current status.
To notify the system of current availability, the surgeon will select the ‘consult’ tab from the menu and depress the button, ‘I am currently available’.
Separately, a surgeon in the OR, who wishes for a consult from a pre-selected peer, may select the “consult” tab. A list of currently available surgeons will appear, who have logged-on to the system.
The consult feature may be utilized for on-going consultations. Or, a list may be built for a surgeon to support a group of attendees for a given post-workshop period.
The consult feature is intended to enable a true peer-to-peer communication. Therefore, in order to add a peer to one's ‘peer’ list, agreement must be mutual.
   Notes

ISDN lines—The SurgiCast™ will enable receipt over ISDN lines, via bridging

Video Codec—Is downloadable for viewing.

*** End of Sample User Specification ***

While certain embodiments are illustrated in the drawings and are described herein, including preferred embodiments, it will be apparent to those skilled in the art that the specific embodiments described herein may be modified without departing from the inventive concepts described.

1. A method of scheduling viewing of a live medical procedure comprising the steps of:
identifying a live medical procedure for viewing based on characteristics of the procedure, the characteristics comprising a scheduled time in which the procedure is to begin, and a procedure type;
accessing a database comprising a record associated with the live medical procedure, the record comprising a plurality of data fields corresponding to the characteristics, each of the plurality of data fields having a value corresponding to one of the characteristics of the procedure;
searching the database to identify the record; and
registering to view the live medical procedure at the scheduled time.

2. The method of claim 1, further comprising a step of viewing the live medical procedure.

3. The method of claim 2, wherein the step of viewing the live medical procedure is performed at a remote location.

4. The method of claim 2, wherein the step of viewing the live medical procedure is performed at a location in proximity to a location at which the live medical procedure is performed.

5. The method of claim 1, further comprising a step of establishing a link between an image acquisition component provided at a location of the live medical procedure and a remotely located viewing component.

6. The method of claim 5, wherein the link is established by submitting registration information to a computer configured to control transmission of an image of the live medical procedure to the remote viewing component.

7. The method of claim 1, wherein the live medical procedure is identified based on characteristics selected from the group consisting of a scheduled time in which the procedure is to begin, a procedure type, a patient's gender, a patient's age, a body region on which the procedure is to be performed, a doctor performing the procedure, a doctor's school, instrumentation used for the live medical procedure, video transmission speed, and a geographic location at which the procedure is to be performed.

8. The method of claim 1, wherein the database is remotely accessed over the Internet.

9. The method of claim 1, further comprising the steps of viewing the live medical procedure in a graphical user interface display partitioned into a plurality of viewing components, a first one of the components configured to display a video image of the live medical procedure, and each additional component configured to permit viewing of supplemental information associated with the live medical procedure.

10. The method of claim 9, wherein the display is partitioned into four viewing components.

11. The method of claim 1, further comprising a step of identifying another viewer registered to view the medical procedure.

12. The method of claim 11, wherein the identification of the other viewer includes determining that the other viewer is viewing the medical procedure.

13. The method of claim 11, wherein the identification of the other viewer includes determining that the other viewer is registered to view the medical procedure.

14. The method of claim 11, wherein the identification of the other viewer includes determining that the other viewer is a member of a system configured to permit the scheduling and viewing of the medical procedure.

15. The method of claim 1, further comprising a step of notifying another person of the live medical procedure.

16. The method of claim 15, wherein the other person is selected from a group of people identified in a list selected by a viewer.

17. The method of claim 15, wherein the notifying step comprises sending an electronic message to the other person which appears in one of a plurality of windows of a viewing component.

18. A method of scheduling viewing of a live medical procedure comprising the steps of:
providing a database with data corresponding to characteristics of a live medical procedure, the characteristics comprising a time in which the live medical procedure is to begin, and a procedure type;
receiving a request from a requestor to schedule viewing of the live medical procedure at the time in which the procedure is scheduled to begin;
acquiring an image of the live medical procedure at the time in which the procedure is being performed; and
transmitting data corresponding to the image of the live medical procedure to a viewing component, in accordance with the request.

19. The method of claim 18, wherein the live medical procedure is a surgical procedure performed at a medical facility.

20. The method of claim 18, wherein the database includes data corresponding to characteristics selected from the group consisting of a scheduled time in which the procedure is to begin, a procedure type, a patient's gender, a patient's age, a body region on which the procedure is to be performed, a doctor performing the procedure, a doctor's school, instrumentation used for the live medical procedure, video transmission speed, and a geographic location at which the procedure is to be performed.

21. The method of claim 18, wherein the request is received over a link of a computer network.

22. The method of claim 18, further comprising a step of registering a viewer to view the live medical procedure in response to the request received from the requestor.

23. The method of claim 22, wherein the step of registering the viewer comprises associating the viewer with an authorization code.

24. The method of claim 18, wherein the image of the live medical procedure is acquired using a digital video camera.

25. The method of claim 18, wherein the acquiring step comprises recording the image of the live medical procedure on a fixed tangible medium.

26. The method of claim 18, wherein the acquiring step comprises transmitting the image of the live medical procedure without recording the image on a fixed tangible medium.

27. The method of claim 18, further comprising a step of transmitting supplementary information related to the medical procedure to the remote viewing component.

28. The method of claim 18, further comprising a step of sending an electronic notification of a change in scheduling of the live medical procedure.

29. The method of claim 18, wherein the request comprises an identity of a remote viewing component.

30. The method of claim 18, further comprising a step of submitting a payment request to the requestor to schedule the viewing of the live medical procedure.

31. The method of claim 18, further comprising a step of providing an authorization code that permits a viewer to view a plurality of live medical procedures at different scheduled times.

32. The method of claim 18, further comprising a step of receiving a request to identify another viewer registered to view the medical procedure.

33. The method of claim 32, wherein the request includes a request to determine that the other viewer is viewing the medical procedure.

34. The method of claim 32, wherein the request includes a request to determine that the other viewer is registered to view the medical procedure.

35. The method of claim 32, wherein the request includes a request to determine that the other viewer is a member of a system configured to permit scheduling and viewing of the medical procedure.

36. The method of claim 18, further comprising the steps of receiving a notice regarding the live medical procedure from a viewer of the live medical procedure, and transmitting the notice to another person.

37. The method of claim 36, wherein the other person is selected from a group of people identified in a list selected by a viewer.

38. The method of claim 36, wherein the transmitting of the notice comprises sending an electronic message to the other viewer which appears in one of a plurality of windows of the viewing component.

39. A system for scheduling viewing of a live medical procedure, comprising:
an image acquisition component configured to acquire an image of a live medical procedure being performed;
a viewing component coupled to the image acquisition component via a link, the viewing component configured to display the image of the live medical procedure received from the image acquisition component; and
a database configured to store data regarding scheduling and performance of the live medical procedure, the database being searchable to permit a requestor to search for the live medical procedure and to register a viewer to view the live medical procedure with the viewing component.

40. The system of claim 39, wherein the image acquisition component comprises a recording component configured to record the image of the live medical procedure on a fixed tangible medium.

41. The system of claim 39, wherein the image acquisition component comprises a transmission component configured to transmit the image of the live medical procedure without recording the image on a fixed tangible medium.

42. The system of claim 39, wherein the image acquisition component comprises at least one video signal.

43. The system of claim 39, wherein the image acquisition component comprises at least one patient monitor.

44. The system of claim 39, wherein the viewing component is located at a remote location.

45. The system of claim 39, wherein the viewing component is located in proximity to the location of the live medical procedure.

46. The system of claim 39, wherein the database comprises fields corresponding to characteristics of the live medical procedure selected from the group consisting of a scheduled time in which the procedure is to begin, a procedure type, a patient's gender, a patient's age, a body region on which the procedure is to be performed, a doctor performing the procedure, a doctor's school, instrumentation used for the live medical procedure, video transmission speed, and a geographic location at which the procedure is to be performed.

47. The system of claim 39, further comprising a data management component in communication with the database.

48. The system of claim 39, further comprising a reservation component configured to permit a requestor to register for viewing the live medical procedure.

49. The system of claim 39, further comprising a list of names of people effective in facilitating electronic communication between people of the list.

50. The system of claim 49, wherein the list includes a plurality of groups of people associated by personal profile information.
